(19) United States
(12) Patent Application Publication
(10) Pub. No.: US 2026/0164304 A1
(43) Pub. Date: Jun. 11, 2026

(54) VOICE CALL AUTHNETICATION SERVER LOAD BALANCING IN TELECOMMUNICATIONS NETWORKS

(71) Applicant: DISH Wireless L.L.C., Englewood, CO (US)

(72) Inventors: Krupal Kumar Patel, Parker, CO (US); Sruthi Nair, Aurora, CO (US); Mohammad Dawood Shahdad, Aurora, CO (US)

(21) Appl. No.: 18/976,765

(22) Filed: Dec. 11, 2024

(51) Int. Cl. H04W 28/08; H04L 9/40; H04L 65/1016

(52) U.S. Cl. CPC H04W 28/08; H04L 63/0823; H04L 65/1016

(57) ABSTRACT

Systems and methods of voice call authentication perform and/or comprise receiving an incoming call request at a first network node of an Internet Protocol Multimedia Subsystem (IMS) Core associated with the telecommunications network; for each of a plurality of candidate application servers in the IMS core, resolving a health status by a load balancer of the IMS Core; routing the incoming call request to a selected application server of the plurality of candidate application servers based on the resolved health statuses; determining whether the incoming call request is authentic by the selected application server; and in response to a determination that the incoming call request is authentic, forwarding the incoming call request to a target user equipment (UE) in the telecommunications network.

### BACKGROUND

This disclosure relates to wireless data networks, such as 5G wireless networks. Wireless networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers, and other devices. 5G technologies are capable of supplying much greater bandwidths than previously available technologies.

The discussion above is merely provided for general background information and is not intended to be used as an aid in determining the scope of the claimed subject matter.

### SUMMARY

Various aspects of the present disclosure relate to systems and methods in a telecommunications network to provide dynamic selection of session functions.

According to one aspect of the present disclosure, a method of performing voice call authentication in a telecommunications network is provided. The method comprises receiving an incoming call request at a first network node of an Internet Protocol Multimedia Subsystem (IMS) Core associated with the telecommunications network; for each of a plurality of candidate application servers in the IMS core, resolving a health status by a load balancer of the IMS Core; routing the incoming call request to a selected application server of the plurality of candidate application servers based on the resolved health statuses; determining whether the incoming call request is authentic by the selected application server; and in response to a determination that the incoming call request is authentic, forwarding the incoming call request to a target user equipment (UE) in the telecommunications network.

According to another aspect of the present disclosure, a telecommunications network is provided. The network comprises at least one first processor in communication with a first network node of an Internet Protocol Multimedia Subsystem (IMS) Core associated with the telecommunications network; and a first memory storing first instructions that, when executed by the at least one first processor, cause the first network node to: receive an incoming call request at a first network node of an Internet Protocol Multimedia Subsystem (IMS) Core associated with the telecommunications network, for each of a plurality of candidate application servers in the IMS core, resolve a health status by a load balancer of the IMS Core, route the incoming call request to a selected application server of the plurality of candidate application servers based on the resolved health statuses, determine whether the incoming call request is authentic by the selected application server, and in response to a determination that the incoming call request is authentic, forward the incoming call request to a target user equipment (UE) in the telecommunications network.

According to another aspect of the present disclosure, a non-transitory computer-readable medium is provided. The non-transitory computer-readable medium stores instructions that, when executed by at least one processor of a first network node in an Internet Protocol Multimedia Subsystem (IMS) Core associated with a telecommunications network, cause the first network node to perform operations comprising receiving an incoming call request at a first network node of an Internet Protocol Multimedia Subsystem (IMS) Core associated with the telecommunications network; for each of a plurality of candidate application servers in the IMS core, resolving a health status by a load balancer of the IMS Core; routing the incoming call request to a selected application server of the plurality of candidate application servers based on the resolved health statuses; determining whether the incoming call request is authentic by the selected application server; and in response to a determination that the incoming call request is authentic, forwarding the incoming call request to a target user equipment (UE) in the telecommunications network.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3 illustrates an example of an IP Multimedia Subsystem configuration in accordance with a comparative example.

FIG. 4A illustrates an example of an IP Multimedia Subsystem configuration in accordance with various aspects of the present disclosure.

FIG. 4B illustrates an example of an IP Multimedia Subsystem configuration in accordance with various aspects of the present disclosure.

FIG. 5 illustrates an example of an authentication server load balancing method in accordance with various aspects of the present disclosure.

FIG. 6 illustrates an example of an authentication server load balancing system in accordance with various aspects of the present disclosure.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is directed to wireless communications networks, also referred to herein as telecommunications networks. The systems and methods set forth herein may be implemented on a telecommunications network in compliance with any telecommunication standard or group of standards; for example, fourth-generation (4G) network standards such as Long Term Evolution (LTE) and/or fifth-generation (5G) network standards such as New Radio (NR). In an example implementation, the wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a 5G network, such as, e.g., a 5G cellular network. Such 5G networks, including the wireless communication networks described herein, may comply with industry standards, such as, e.g., the Open Radio Access Network (Open RAN or O-RAN) standard that describes interactions between the network and user equipment (e.g., mobile phones and the like).

The O-RAN model follows a virtualized model for a cloud-native 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using general-purpose computing resources. Such general-purpose computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as Amazon Web Services (AWS).

For voice communications, including Voice over LTE (VoLTE) using 5G networks, Voice over Wi-Fi (VoWi-Fi) using wireless internet networks, and Voice over NR (VoNR) using 5G networks, an Internet Protocol (IP) Multimedia Subsystem (IMS) framework may be provided. Collectively, these may referred to as Voice over IMS (VoIMS). By using VoIMS technologies, communications are routed via an IMS Core such that connections can be established and maintained between users of a first network and users of a second network, even if the second network is different from the first network, and even if the second network is based on a different architecture than the first network (e.g., between NR users and LTE users).

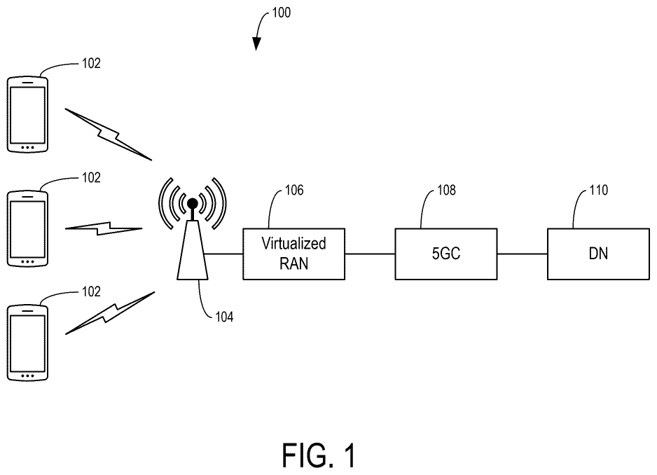

FIG. 1 illustrates an example of a telecommunications network 100 in accordance with various aspects of the present disclosure. In the telecommunications network 100 of FIG. 1, a plurality of UEs 102 are connected to a wireless access point 104, which in turn is connected to a set of virtualized RAN components 106. The virtualized RAN components 106 provide a connection to a 5G core network (5GC) 108, which in turn provides a connection to a data network 110. The wireless access point 104 and the virtualized RAN components 106 may collectively be referred to as a next-generation RAN (NG-RAN).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network capable of being virtualized.

As used herein, the term “UE” may be one of various types of end-user devices, such as cellular phones, smartphones, cellular modems, cellular-enabled computerized devices, sensor devices, robotic equipment, vehicles, IoT devices, gaming devices, access points (APs), or any computerized device capable of communicating via a cellular network. More generally, a UE 102 can represent any type of device that has an incorporated 5G interface, such as a 5G modem. Examples can include sensor devices, Internet of Things (IoT) devices, manufacturing robots, unmanned aerial (or land-based) vehicles, network-connected vehicles, etc. Depending on the location of individual UEs, a UE 102 may use RF to communicate with various base stations of a telecommunications network. While FIG. 1 illustrates three UEs 102 connected to the wireless access point 104, in practical implementations any number of UEs 102 may be connected to the wireless access point 104 at any given time.

The wireless access point 104 represents the physical infrastructure (e.g., a 5G tower) to which the UEs 102 connect. The wireless access point 104 may be any structure to which one or more antennas are mounted. The wireless access point 104 may be a dedicated cellular tower, a building, a water tower, or any other man-made or natural structure to which one or more antennas can reasonably be mounted to provide cellular coverage to a geographic area. The wireless access point 104 may include an RU configured to convert radio signals sent to and received from the antenna(s) into a digital signal. The wireless access point 104 is connected to the virtualized RAN components 106 via a fronthaul link over which the digital signals may be communicated. The virtualized RAN components 106 may include a DU connected to a CU via a midhaul link. The CU may be connected to the 5 GC 108 via a backhaul link. While FIG. 1 illustrates a single wireless access point 104 and a single set of virtualized RAN components 106, in practical implementations the telecommunications network 100 may include any number of wireless access points 104 and/or any number of virtualized RAN components 106.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center of a group of data centers that allows for redundancy, thereby to provide fail-over protection from other availability zones within the same cloud computing region. For example, if a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites. A site may have one DU and a number of RUs (e.g., six RUs) assigned to it.

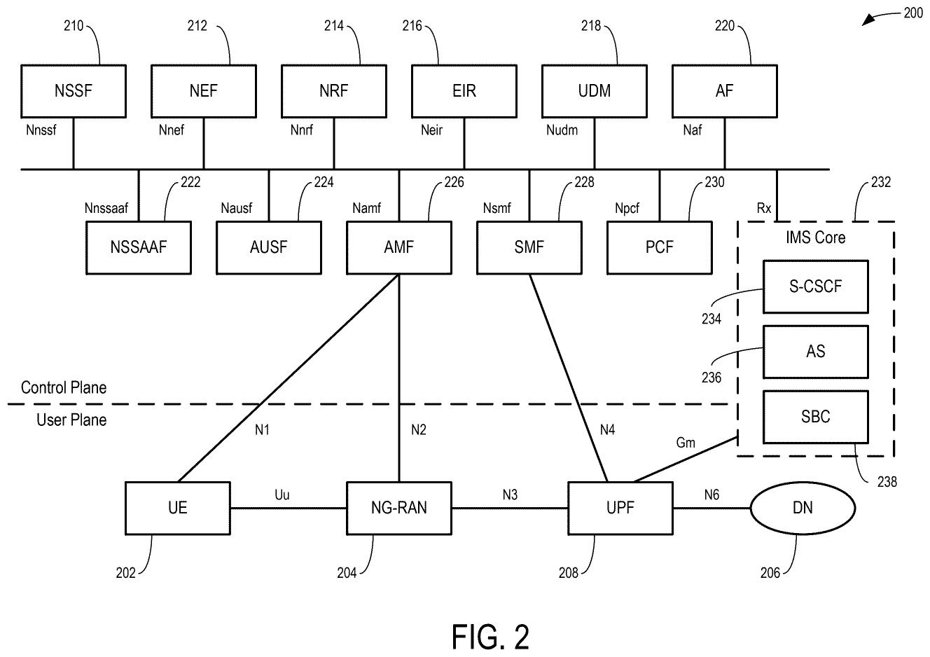

The 5 GC 108 provides a plurality of 5G core functions. In the topology of a 5G NR cellular network, 5G core functions of 5GC 108 can logically reside as part of a national data center (NDC). An NDC can be understood as having its functionality existing in a cloud computing region across multiple availability zones. This arrangement allows for load-balancing, redundancy, and fail-over. In local zones, multiple regional data centers can be logically present. Each of regional data centers may execute 5G core functions for a different geographic region or group of RAN components. An example of 5G core components that can be executed within an RDC are described in more detail with regard to FIG. 2. The data network 110 may be the Internet, an enterprise data network, combinations thereof, and the like.

FIG. 2 illustrates an example service-based architecture (SBA) 200 for a telecommunications network (e.g., the telecommunications network 100 of FIG. 1) in accordance with various aspects of the present disclosure. The SBA 200 includes an infrastructure domain, which is divided between a control plane (CP) and a user plane (UP), both of which are in communication with the IMS core 232. The CP comprises a plurality of CP network functions (NFs). The UP comprises a UE 202 (e.g., one of the UEs 102 of FIG. 1) connected to an NG-RAN 204, and UP NFs. Using the SBA 200, the UE 202 accesses a data network 206 (e.g., the data network 110 of FIG. 1) and voice services via the IMS core 232. For ease of illustration, FIG. 2 only shows a single UE 202 being connected to the NG-RAN 204; however, in practical implementations any number of UEs 202 may be present, limited only by the capacity of the network.

The UP NFs include a User Plane Function (UPF) 208. The UPF 208 is a network function that routes and forwards user plane data packets between the base station (cell site; for example, the NG-RAN 204) and the external data network 206 (e.g., the Internet), and routes and forwards voice packets between the base station and the IMS core 232. The UPF 208 is similar to the service and packet gateway functions in a 4G network, but it is cloud-native and can be deployed anywhere to meet service requirements. It can also manage, prioritize, and duplicate data packets as they traverse the network, thus offering redundancy and quality-of-service (QoS) assurance.

The CP NFs include a Network Slice Selection Function (NSSF) 210, a Network Exposure Function (NEF) 212, a Network Repository Function (NRF) 214, an Equipment Identity Register (EIR) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, and a Policy Control Function (PCF) 230.

The NSSF 210 is a CP function that provides network slices to the AMF 226. A network slice is an independent, end-to-end logical network that runs on shared physical network infrastructure. It involves the allocation of network resources across all network infrastructure to meet specific service requirements, from the network core to the radio access network (RAN). Specific requirements may include QoS assurance, security policies, data isolation, dynamic policy management, etc.

The NEF 212 is a CP function that provides information regarding the network functions that are available to use (by the enterprise customer). It is similar to the 4G Service Capabilities Exposure Function (SCEF), but it is cloud-native and exposes event information, network monitoring, network control, provisioning capabilities, and policy/charging capabilities externally. This allows the enterprise customer to monitor and affect QoS and charging for devices.

The NRF 214 is a CP function that allows 5G network functions to be registered, discovered, and subsequently made available to customers. This is a unique capability in the standalone 5G network that allows customers to subscribe to the necessary microservices or to have dedicated network functions for their services.

The EIR 216 (sometimes referred to as a “5G-EIR”) is a CP function that provides the ability to check the status of a UE's identity, for example to determine whether the UE has been blacklisted from the network. The services provided by the EIR 216 are consumed by the AMF 226. It may be invoked during any procedure establishing a signaling connection between a UE and the network based on an equipment identifier of the UE.

The UDM 218 is a CP function that manages and stores subscriber and device information, default QoS and prioritization, authorized data channels, maximum bit rates, service continuity provisions, and the like. The UDM 218 is similar to the Home Subscriber Server (HSS) function in a 5G network, but it is cloud-native and designed for 5G services.

The AF 220 is a CP function that interacts with the 3GPP Core Network in order to provide services, for example to support one or more of application function influence on traffic routing, application function influence on service function chaining, accessing the NEF 212, interacting with the PCF 230, time synchronization service, IP multimedia subsystem (IMS) interactions with the 5GC, or packet data unit (PDU) set handling.

The NSSAAF 222 is a CP function that supports authentication and authorization of slicing with an AAA server (Authentication, Authorization, and Accounting). It is a unique capability of the standalone 5G network that allows customers to access a predefined network slice or a newly requested network slice in real-time and using their own existing authentication infrastructure.

The AUSF 224 is a CP function that supports authentication for 3GPP access and untrusted non-3GPP access, and authentication of a UE for a disaster roaming service. It can act as an authentication server.

The AMF 226 is a CP function that manages registration, authorization, connection, reachability, and mobility. It is similar to the Mobility Management Entity (MME) function in a 4G network, but it is cloud-native and supports many additional capabilities unique to 5G. For example, it also supports dynamic updating of network interfaces and cellular sites, greater privacy via the use of a 5G temporary device identity, enhanced security across the user and control planes, and stores network slice information. It can also select an appropriate PCF for a device or use case.

The SMF 228 is a CP function that oversees packet data session management, IP address allocation, data tunneling from a cell site base station to the user plane function, and downlink notification management. It performs the tasks of the serving and packet gateways (S-GW & P-GW) in a 4G network, but also allows for control plane and user plane separation in 5G.

The PCF 230 is a CP function that provides policies for mobility and session management. It is similar to the Policy and Charging Rules Function (PCRF) in a 4G network, but it is cloud-native and offers additional capabilities in the 5G network, including event-based policy triggers, resource reservation requests, and access network discovery and selection. The PCF 230 directly influences QoS and subscriber spending limits, and as a result plays a role in the enhanced policy management and control capabilities of the 5G network.

The IMS Core 232 provides for globally interoperable voice and communication services. IMS services are provided using several components, including a Serving Call Session Control Function (S-CSCF) 234, an Application Server (AS) 236, and a Session Border Controller (SBC) 238. The S-CSCF 234 provides for both registration and session control for UEs 202. The AS 234 provides for hosting, management, and execution of various services. The SBC 238 may be or include an Access SBC (A-SBC) and/or an Interconnect SBC (I-SBC). The SBC 238 provides a communication endpoint for services between the IMS Core 232 and the UE 202, through which the UE 202 can exchange messages, and may include a Proxy CSCF (P-CSCF) and an Application Level Gateway (ALG). While FIG. 2 illustrates only a single S-CSCF 234, a single AS 236, and a single SBC 238, in practical implementations a number of one or more of the illustrated components may be present, such as a primary S-CSCF/AS/SBC, a secondary S-CSCF/AS/SBC, a tertiary S-CSCF/AS/SBC, and so on. Moreover, the IMS Core 232 may include additional components not expressly illustrated, such as a Telephony Application Server (TAS), an Interrogating CSCF (I-CSCF), and the like.

The SBA 200 further includes a plurality of service-based interfaces to provide access to or communication with the various NFs. As illustrated, these include an Nnssf interface for the NSSF 210, an Nnef interface for the NEF 212, an Nnrf interface for the NRF 214, an Neir for the EIR 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, and an Npcf interface for the PCF 230. FIG. 1 also illustrates several reference points (i.e., interfaces between two NFs or entities), including an N1 interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206. Any of the above-described interfaces may be an SBI interface (e.g., an http2 based interface). FIG. 2 further illustrates an Rx interface between the IMS Core 232 (e.g., the P-CSCF 234) and the 5GC, and a Gm interface between the UPF 208 and the IMS Core 232 (e.g., the P-CSCF 234). The Rx interface and/or the Gm interface may be Diameter interfaces. The individual components within the IMS core 232 may communicate with one another using interfaces, including Session Initiation Protocol (SIP) and/or Hypertext Transfer Protocol (HTTP) interfaces (e.g., http2 interfaces).

The above-listed NFs and interfaces are intended to be illustrative and not exhaustive. In practical implementations, the SBA 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), a Network Data Analytics Function (NWDAF), or a Trusted WLAN Interworking Function (TWIF).

Any of the NFs illustrated in FIG. 2 and/or described above may be implemented as a software unit residing on a server (i.e., in the cloud). Each NF can include multiple pods. A “pod” refers to a software sub-component of the NF. Kubernetes, Docker, or some other container orchestration platform can be used to create and destroy the logical CU or 5G core units and subunits as needed for the data network 110 to function properly. The pods may be deployed on one or more virtual machines configured by a network operator. Kubernetes allows for container deployment, scaling, and management. As an example, if cellular traffic increases substantially in a region, an additional logical CU or components of a CU may be deployed in a data center near where the traffic is occurring without any new hardware being deployed. Instead, processing and storage capabilities of the data center would be devoted to the needed functions. When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers. Thus, the SBA 200 may be implemented on or using one or more computing devices, each of which includes a processor and a memory.

As used herein, a “processor” may include one or more individual electronic processors, each of which may include one or more processing cores, and/or one or more programmable hardware elements. The processor may be or include any type of electronic processing device, including but not limited to central processing units (CPUs), graphics processing units (GPUs), application-specific integrated circuits (ASICs), field-programmable gate arrays (FPGAs), microcontrollers, digital signal processors (DSPs), or other devices capable of executing software instructions. When a device is referred to as “including a processor,” one or all of the individual electronic processors may be external to the device (e.g., to implement cloud or distributed computing). In implementations where a device has multiple processors and/or multiple processing cores, individual operations described herein may be performed by any one or more of the microprocessors or processing cores, in series or parallel, in any combination. In some implementations, one or more of the processing units or processing cores may be remote (e.g., cloud-based).

As used herein, a “memory” may be any storage medium, including a non-volatile medium, e.g., a magnetic media or hard disk, optical storage, or flash memory; a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc. ; on-chip memory; and/or an installation medium where appropriate, such as software media, e.g., a CD-ROM, or floppy disks, on which programs may be stored and/or data communications may be buffered. The term “memory” may also include other types of memory or combinations thereof. For the avoidance of doubt, cloud storage is contemplated in the definition of memory. A memory is an example of a non-transitory computer-readable medium which stores instructions that are executable by a processor (or processors), the execution of which causes the executing device (e.g., a computer) to perform certain operations, such as those operations described herein.

In the SBA 200 shown in FIG. 2, the NG-RAN 204 may include some or all of the virtualized RAN components 106 illustrated in FIG. 1. Thus, the NG-RAN 204 may include at least one CU, at least one DU configured to operate under the control of one or more of the at least one CU, and at least one RU configured to operate under the control of one or more of the at least one DU. For example, each CU in the NG-RAN 204 may control a plurality of DUs, each of which in turn may control a plurality of RUs. Each RU may be operatively connected to a power amplifier and transmission elements (e.g., antennae) configured to cooperate to transmit signals to connected UEs 202 according to a transmission schedule.

In examples, the SBA 200 may be applicable to a particular cloud computing region. For example, as noted above, one instance of the SBA 200 may exist within a first geographical region (e.g., the northeastern United States) while another instance of the SBA 200 may exist within a second geographical region (e.g., the western United States). In this implementation, the above described NFs may be embodied in the form of computing nodes in data centers located within the corresponding geographical region. Thus, the first instance of the SBA 200 may be implemented by computing nodes in one or more data centers physically located in the northeastern United States, the second instance of the SBA 200 may be implemented by computing nodes in one or more data centers physically located in the western United States, and so on. Within each instance of the SBA 200, the computing nodes may be configured to implement at least instance of each of the above-described NFs.

The NFs operate together (e.g., with one another and/or with components of the IMS Core) to perform and/or manage various procedures within the network, including connection, registration, authentication, and mobility management procedures. For example, components of the IMS Core 232 may operate to authenticate identification information for voice calls, thereby to reduce or prevent the ability of callers to spoof a caller ID. In 3GPP-based implementations, the authentication may be performed according to a set of standards referred to as Secure Telephone Identity Revisited (STIR) and Signature-based Handling of Asserted Information Using toKENs (SHAKEN), collectively referred to as the STIR/SHAKEN framework. These standards use a cryptographically-signed SIP header in order to help verify the origin of a telephone call, for example using an authentication service provided by a network component (e.g., a server located within the IMS Core 232).

For STIR/SHAKEN authentication, a public encryption key can be stored by an enterprise reputation service in a key certificate manager. The key certificate manager, which can include a key management server (KMS), can function as a part of the enterprise reputation service. When an incoming voice call request is received, a voice calling service system in the receiving network can access the enterprise reputation service (and in particular the key certificate manager) to obtain public keys used for decryption. If there is a trusted peer relationship between the originating network and the receiving network, the public key may be obtained from a peer key certificate database of the originating network directly. If there is no peer relationship between the originating network and the receiving network, the public key may be obtained via a certificate authority. A service (e.g., run by AS 236) in the receiving network may check whether the caller ID is accurate or fraudulent by decrypting a STIR certificate in the incoming call request using the public key.

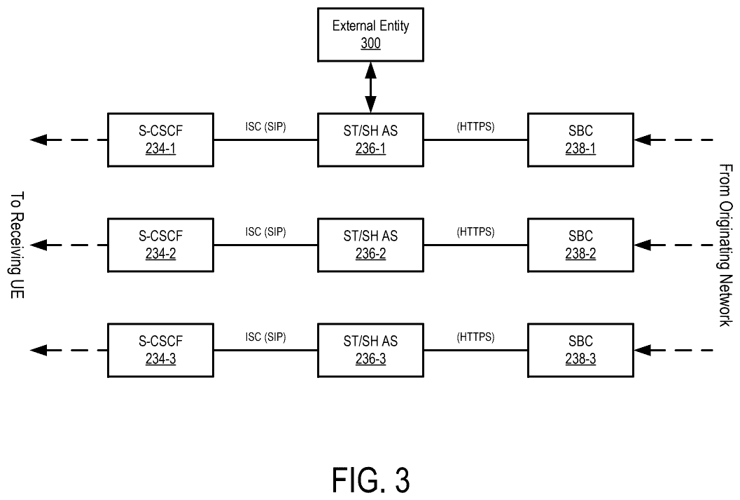

FIG. 3 illustrates an example of a portion of IMS Core 232 and its implementation of a STIR/SHAKEN authentication procedure performed according to a comparative example. In the illustration of FIG. 3, three instances of an S-CSCF 234-1 to 234-3, three instances of a STIR/SHAKEN Application Server 236-1 to 236-3, and three instances of an SBC 238-1 to 238-3 are shown for purposes of explanation. The network elements are connected in a one-to-one (daisy chain) manner, such that the first S-CSCF 234-1 is connected to the first ST/SH AS 236-1 via a IMS Service Control Interface (ISC) based on SIP, and the first ST/SH AS 236-1 is in turn connected to the first SBC 238-1 via an interface based on HTTP. In practice, any number of S-CSCFs 234, ST/SH ASs 236, and SBCs 238 may be present. The IMS Core includes an external entity 300, which may an AS for verification (that is, an HTTP-based application server that performs the function of a verification service, for example by verifying the digital signature of an incoming call). The external entity 300 may include or be in communication with a Certificate Repository (CR). While the external entity 300 is illustrated as being only connected to the first ST/SH AS 236-1, in practice the external entity 300 may be connected to all ST/SH ASs 236-1 to 236-3.

A voice call request is received at one of the SBCs 238-1 to 238-3 (e.g., via an Interconnection Border Control Function (IBCF)) from an originating network, which may be a different network (i.e., inter-network telephony) or the same network (i.e., intra-network telephony). The voice call request includes a STIR certificate, which may be embodied in the form of a Personal Assertion Token (PASSporT) within an SIP identity header. The receiving SBC 238 then forwards the request to the corresponding ST/SH AS 236, which communicates with the external entity 300 to authenticate the STIR certificate and thereby verify an identity of the caller. However, this comparative example does not have ST/SH AS redundancy (i.e., each SBC 238 is only in communication with one ST/SH AS 236). Therefore, if the ST/SH AS 236 goes down or has issues connecting to the external entity 300, it will be unable to validate calls and may, for example, directly pass calls to the receiving UE whether the call is legitimate/legal or illegitimate/illegal.

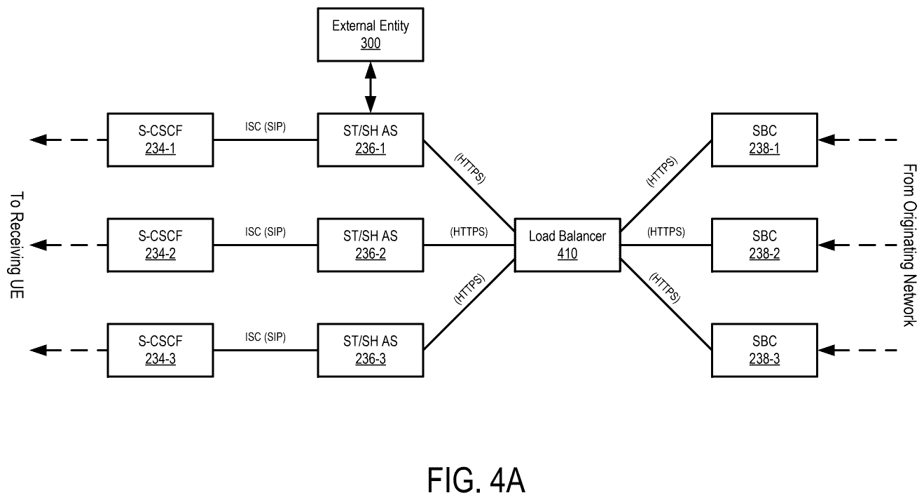

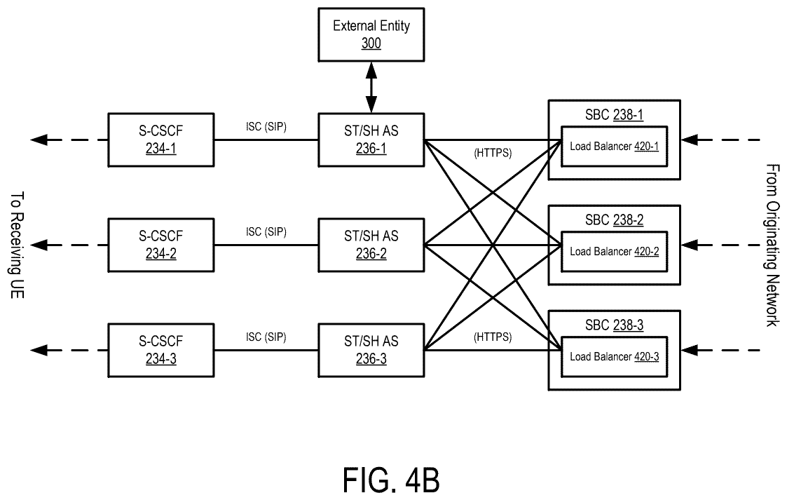

To overcome this and other deficiencies in the comparative examples, the present disclosure implements load balancing to continually monitor server health and route calls and call requests accordingly. FIGS. 4A and 4B illustrate examples of a portion of IMS Core 232 and its implementation of a STIR/SHAKEN authentication procedure performed according to the present disclosure. In both of FIGS. 4A and 4B, three instances of an S-CSCF 234-1 to 234-3, three instances of a STIR/SHAKEN Application Server 236-1 to 236-3, and three instances of an SBC 238-1 to 238-3 are shown for purposes of explanation. In practice, any number of S-CSCFs 234, ST/SH ASs 236, and SBCs 238 may be present. As in the comparative example, an external entity 300 is present, which may be an AS for verification (that is, an HTTP-based application server that performs the function of a verification service, for example by verifying the digital signature of an incoming call). The external entity 300 may include or be in communication with a Certificate Repository (CR). While the external entity 300 is illustrated as being only connected to the first ST/SH AS 236-1, in practice the external entity 300 may be connected to all ST/SH ASs 236-1 to 236-3.

In the example of FIG. 4A, a load balancer 410 is disposed between the ST/SH ASs 236-1 to 236-3 and the SBCs 238-1 to 238-3. The load balancer 410 is connected to all of the T/SH ASs 236-1 to 236-3 and the SBCs 238-1 to 238-3 via an interface based on HTTP. While FIG. 4A illustrates only one load balancer 410, in practice any number of load balancers 410 may be present, and connected to any number of ST/SH ASs 236 and any number of SBCs 238. In such implementations, some or all of the ST/SH ASs 236 and/or the SBCs 238 may be connected to multiple load balancers 410, for example to provide redundancy. The load balancer 410 continually monitors the health of all connected ST/SH ASs 236, and may include internal logic to perform monitoring or other operations. The monitoring may be performed at predetermined intervals, which may be defined in the load balancer 410 itself. At the time of receiving a call request, the receiving SBC 238 routes the request to the load balancer 410, which then routes the request to a ST/SH AS 236 that the load balancer 410 has determined is healthy or most healthy (e.g., operable, operating efficiently, etc.). If multiple ST/SH ASs 236 are determined to have equal health, the load balancer 410 may route the request via, for example, least-cost methods, round robin, methods, random methods, or combinations thereof. Such routing mechanisms may be based on existing network settings and/or may be configurable by the network operator.

In the example of FIG. 4B, load balancing is implemented in the form of a microservice within an existing IMS Core node. In this example, each SBC 238-1 to 238-3 is configured with a load balancer microservice 420-1 to 420-3 therein. Each SBC 238-1 to 238-3 is connected to each ST/SH AS 236-1 to 236-2 via an interface based on HTTP. As in the example of FIG. 4A, the load balancer microservices 420 continually monitor the health of all connected ST/SH ASs 236, and may include internal logic to perform monitoring or other operations. The monitoring may be performed at predetermined intervals, which may be defined in the load balancer microservice 420 itself. At the time of receiving a call request, the receiving SBC 238 invokes the load balancer microservice 420 therein, which then routes the request to a ST/SH AS 236 that the load balancer microservice 420 has determined is healthy or most healthy (e.g., operable, operating efficiently, etc.). If multiple ST/SH ASs 236 are determined to have equal health, the load balancer microservice 420may route the request via, for example, least-cost methods, round robin, methods, random methods, or combinations thereof. Such routing mechanisms may be based on existing network settings and/or may be configurable by the network operator.

Thus, according to either the example of FIG. 4A or the example of FIG. 4B, the IMS Core is much more resilient to failures in the ST/SH ASs 236 and thus will not directly pass illegal or illegitimate calls or messages to the receiving UE.

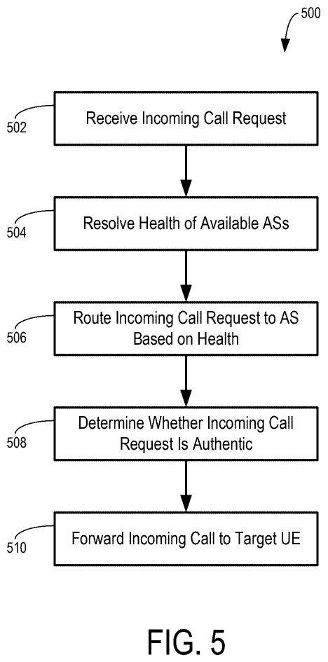

FIG. 5 illustrates an example method 500 of performing voice call authentication. In an example, the method 500 may be performed by one or more network nodes corresponding to portions of the IMS Core illustrated in FIGS. 4A and 4B. For example, the method 500 may be performed by or under the control of the SBC(s) 238 and load balancer 410 of FIG. 4A, and/or by or under the control of the load balancer microservice(s) 420 operating within the SBC(s) 238 of FIG. 4B. Any of the above-described network nodes may, separately or in combination, be implemented as a cloud computing node located at a data center associated with a cloud computing region of a network in accordance with the present disclosure.

The method 500 begins with an operation 502 of receiving an incoming call request, and as such the action of receiving the incoming call request may initiate the performance of the method 500. Operation 502 may be performed by, at, or under the control of a first network node of an IMS Core associated with a telecommunications network implementing the method 500. In examples, the first network node may be associated with an SBC. The incoming call request may include a digital certificate (e.g., a PASSporT certificate), for example in an SIP Identity header of the incoming call request. The incoming call request may be received from the telecommunications network itself, or may be received from a different telecommunications network (e.g., a network operated by a different network provider and/or in a different geographical area).

The method further includes an operation 504 of resolving a health status for each of a plurality of candidate application servers (e.g., ST/SH ASs) in the IMS Core. Operation 504 may include querying the candidate application servers and determining the health status based on the response (or lack thereof) received from the candidate application servers. Operation 504 may be performed by, at, or under the control of a load balancer in the IMS Core. The load balancer may be a component of a separate network node of the IMS Core (e.g., as illustrated in FIG. 4A) and/or a microservice operating on the first network node (e.g., as illustrated in FIG. 4B). In either case, while FIG. 5 illustrates operation 504 being performed directly following operation 502, in practical implementations operation 504 may instead be performed at predetermined intervals (e.g., as determined by a network operator) and the health status may be stored in a memory of the load balancer. The health status may be a binary indicator (e.g., healthy/not healthy) or a continuous variable (e.g., a health score). The health status may be indicative of a connection status of the application server (e.g., online or offline), an available processing power of the application server, an available memory of the application server, an available communication bandwidth of the application server, etc.

At operation 506, the incoming call request is routed to a selected application server from among the plurality of candidate application servers, based on the resolved health statuses. For example, the incoming call request may be routed to a healthiest ST/SH AS determined by the load balancer. The target ST/SH AS may be selected (e.g., by the load balancer) from among all healthy ST/SH ASs (e.g., if multiple ST/SH ASs are similarly healthy) according to any selection methodology, such as a round robin method, a least-cost method, a random method, etc.

The selected application server may then, at operation 508, determine whether the incoming call request is authentic. Operation 508 may include transmitting the digital certificate (received as part of the incoming call request at operation 502) to an external entity. Operation 508 may further include performing an authentication procedure, for example by the external entity. The authentication procedure may be a STIR/SHAKEN procedure. The external entity may then return the results of the authentication procedure to the requesting ST/SH AS.

If, at operation 508, it is determined that the incoming call request is not authentic, the incoming call request may be rejected or no further action may be taken. If, at operation 508, it is determined that the incoming call request is authentic, then at operation 510 the incoming call request may be forwarded to a target UE (e.g., via a S-CSCF, which then relays the incoming call request to one or more CP NFs in the Control Plane of the telecommunications network and/or to the UPF in the User Plane of the telecommunications network). In some examples, the ST/SH AS may forward the call request to the S-CSCF; however, in other examples the ST/SH AS may return the results of the authentication procedure to the SBC, which will in turn forward the call request to the S-CSCF. Thus, if the incoming call request is in accordance with the authentication protocol (e.g., the STIR/SHAKEN protocol), the voice call may be initiated.

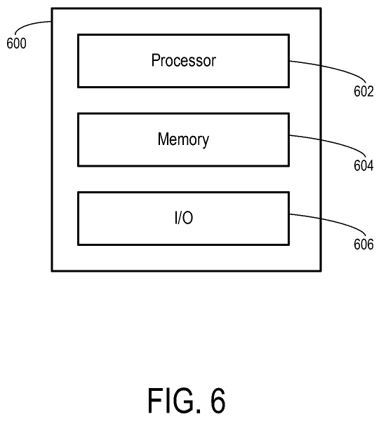

FIG. 6 illustrates one example of a voice call authentication node 600, which is itself an example of a computing node configured to implement the method 500 described above. As illustrated, the voice call authentication node 600 comprises a processor 602, a memory 604, and an input/output (I/O) interface 606. The voice call authentication node 600 may be configured with various modules (e.g., various software modules) to implement identity check, authentication, and/or other logical functions. In some implementations, the voice call authentication node 600 may correspond to one of the above described network nodes (e.g., a network node associated with one or more NFs and/or one or more IMS Core entities). In one example, the dynamic voice call authentication node 600 is associated with an SBC, a load balancer, an AS, and/or a S-CSCF of the network. In examples, multiple iterations of the voice call authentication node 600 (or nodes similarly structured to the voice call authentication node 600) may be provided within the network, each configured with modules to perform one or more of the operations of the method 500.

In one example, the modules may be present in the memory 604 in the form of instructions that, when executed by the processor 602, cause the voice call authentication node 600 to perform any one or more of the operations described herein. In another example, the processor 602 may be configured to load and/or execute instructions from another non-transitory computer-readable medium (e.g., cloud storage or from the memory of another device). In some examples, the following modules may be in the form of xApps and/or rApps (or portions or combinations thereof).

The voice call authentication node 600 may comprise a logic module configured to perform various determinations and other logical operations. In the example in which the voice call authentication node 600 is associated with an SBC, the logic module may be configured to generate and/or execute instructions to receive an incoming call request (e.g., via the I/O interface 606), to resolve a health status of one or more candidate ASs within the IMS Core (e.g., if the load balancer is implemented as a microservice of the SBC), and/or to route the incoming call request to a selected AS based on the resolved health statuses (e.g., if the load balancer is implemented as a microservice of the SBC). In the example in which the voice call authentication node 600 is associated with a separate load balancer (e.g., as illustrated in FIG. 4A), the logic module may be configured to generate and/or execute instructions to resolve a health status of one or more candidate ASs within the IMS Core, and/or to route the incoming call request to a selected AS based on the resolved health statuses. In the example in which the voice call authentication node 600 is associated with an AS, the logic module may be configured to generate and/or execute instructions to determine whether the incoming call request is authentic. In examples in which the voice call authentication node 600 is associated with an S-CSCF, the logic module may be configured to generate and/or execute instructions to forward the incoming call request to a target UE within the terminating network.

The I/O interface 606 may include interface components to permit the communication of data to and from external devices or sources. For example, the I/O interface 606 may include communication ports and/or interfaces to permit communication with other computer devices. The communication ports and/or interfaces may permit input and output via wired protocols (e.g., Ethernet, Universal Serial Bus (USB), FireWire, etc.) and/or wireless protocols (e.g., Wi-Fi, Bluetooth, Near Field Communication (NFC), 5G, 4G, etc.). The I/O interface 606 may additionally or alternatively include communication ports and/or interfaces to permit communication with a user. For example, the I/O interface 606 may include interfaces for a mouse, a keyboard, a display, a graphical user interface (GUI), buttons, switches, etc.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A method of performing voice call authentication in a telecommunications network, the method comprising:
receiving an incoming call request at a first network node of an Internet Protocol Multimedia Subsystem (IMS) Core associated with the telecommunications network;
for each of a plurality of candidate application servers in the IMS core, resolving a health status by a load balancer of the IMS Core;
routing the incoming call request to a selected application server of the plurality of candidate application servers based on the resolved health statuses;
determining whether the incoming call request is authentic by the selected application server; and
in response to a determination that the incoming call request is authentic, forwarding the incoming call request to a target user equipment (UE) in the telecommunications network.

2. The method of claim 1, wherein the load balancer is a component of a second network node of the IMS Core.

3. The method of claim 1, wherein the load balancer is a microservice operating on the first network node.

4. The method of claim 1, wherein the incoming call request includes a digital certificate.

5. The method of claim 4, wherein determining whether the incoming call request is authentic includes transmitting the digital certificate from the selected application server to an external entity, and performing an authentication procedure by the external entity.

6. The method of claim 5, wherein the authentication procedure is a Secure Telephone Identity Revisited and Signature-based Handling of Asserted Information Using toKENs (STIR/SHAKEN) procedure.

7. The method of claim 1, wherein the operation of resolving the health status is performed at predetermined intervals.

8. A telecommunications network comprising:
at least one first processor in communication with a first network node of an Internet Protocol Multimedia Subsystem (IMS) Core associated with the telecommunications network; and
a first memory storing first instructions that, when executed by the at least one first processor, cause the first network node to:
receive an incoming call request at a first network node of an Internet Protocol Multimedia Subsystem (IMS) Core associated with the telecommunications network,
for each of a plurality of candidate application servers in the IMS core, resolve a health status by a load balancer of the IMS Core,
route the incoming call request to a selected application server of the plurality of candidate application servers based on the resolved health statuses,
determine whether the incoming call request is authentic by the selected application server, and
in response to a determination that the incoming call request is authentic, forward the incoming call request to a target user equipment (UE) in the telecommunications network.

9. The network of claim 8, further comprising:
at least one second processor in communication with a second network node of IMS Core; and
a second memory storing second instructions that, when executed by the at least one second processor, cause the second network node to operate as the load balancer.

10. The network of claim 8, wherein the first instructions, when executed by the at least one first processor, cause the first network node to operate the load balancer as a microservice of the first network node.

11. The network of claim 8, wherein the incoming call request includes a digital certificate.

12. The network of claim 11, wherein determining whether the incoming call request is authentic includes transmitting the digital certificate from the selected application server to an external entity, and performing an authentication procedure by the external entity.

13. The network of claim 12, wherein the authentication procedure is a Secure Telephone Identity Revisited and Signature-based Handling of Asserted Information Using toKENs (STIR/SHAKEN) procedure.

14. The network of claim 8, wherein the first network node is associated with a Session Border Controller (SBC) of the IMS Core.

15. A non-transitory computer-readable medium storing instructions that, when executed by at least one processor of a first network node in an Internet Protocol Multimedia Subsystem (IMS) Core associated with a telecommunications network, cause the first network node to perform operations comprising:
receiving an incoming call request at a first network node of an Internet Protocol Multimedia Subsystem (IMS) Core associated with the telecommunications network;
for each of a plurality of candidate application servers in the IMS core, resolving a health status by a load balancer of the IMS Core;
routing the incoming call request to a selected application server of the plurality of candidate application servers based on the resolved health statuses;
determining whether the incoming call request is authentic by the selected application server; and
in response to a determination that the incoming call request is authentic, forwarding the incoming call request to a target user equipment (UE) in the telecommunications network.

16. The non-transitory computer-readable medium of claim 15, wherein the load balancer is a component of a second network node of the IMS Core.

17. The non-transitory computer-readable medium of claim 15, wherein the load balancer is a microservice operating on the first network node.

18. The non-transitory computer-readable medium of claim 15, wherein the incoming call request includes a digital certificate.

19. The non-transitory computer-readable medium of claim 18, wherein determining whether the incoming call request is authentic includes transmitting the digital certificate from the selected application server to an external entity, and performing an authentication procedure by the external entity.

20. The non-transitory computer-readable medium of claim 19, wherein the authentication procedure is a Secure Telephone Identity Revisited and Signature-based Handling of Asserted Information Using toKENs (STIR/SHAKEN) procedure.
